(19) United States
(12) Patent Application Publication
(10) Pub. No.: US 2025/0265521 A1
(43) Pub. Date: Aug. 21, 2025

(54) AUTOMATIC WORKFLOW TEMPLATE GENERATION FROM TEXT INPUT

(71) Applicant: ServiceNow, Inc., Santa Clara, CA (US)

(72) Inventors: Amine El Hattami, Erlenbach (CH); Luke Kumar, Vaughan (CA); Jing Fei Chen, San Francisco, CA (US); Jacob S. Burman, Carlsbad, CA (US)

(21) Appl. No.: 18/442,916

(22) Filed: Feb. 15, 2024

(51) Int. Cl. G06Q 10/0631; G06F 40/103; G06F 40/186

(52) U.S. Cl. CPC G06Q 10/06316; G06F 40/103; G06F 40/186

(57) ABSTRACT

A workflow management and automation tool is disclosed. A plurality of workflow patterns is clustered into one or more workflow pattern clusters based at least in part on a plurality of existing workflows and associated specifications. A specification of a desired workflow is received. A template for the desired workflow is generated via a workflow predictive model. The generating of the template includes identifying one of the one or more of workflow pattern clusters corresponding to the specification of the desired workflow. The generating of the template includes using a portion of the workflow predictive model trained using the identified one workflow pattern cluster to generate the template for the desired workflow.

### BACKGROUND OF THE INVENTION

Workflow management involves identifying, categorizing, structuring, tracking, documenting, and optimizing business tasks and processes to ensure that they proceed smoothly and accurately towards the desired results. A workflow management system provides an infrastructure for the set-up, performance, and monitoring of a defined sequence of tasks.

Correctly applied, workflow management brings together clear visibility, process automation, and support tools to guide people and processes. Additionally, teams that operate within reliable workflows see greater productivity and efficiency, and they are more goal-oriented than those who do not. This comes from having easy access to workflow data, allowing for increased visibility into the steps and processes involved and which roles are responsible for which actions.

### BRIEF DESCRIPTION OF THE DRAWINGS

Various embodiments of the invention are disclosed in the following detailed description and the accompanying drawings.

FIG. 1 illustrates an exemplary set of step-by-step descriptions 100 for creating a workflow to handle a received email.

FIG. 2 illustrates an iterative and automated workflow creation process 200 that requires the user to describe the desired workflow in a step-by-step manner.

FIG. 3 illustrates an exemplary workflow management and automation tool 300 that automatically generates a workflow based on a user specified business requirement.

FIG. 4 illustrates an exemplary process 400 for generating a base workflow based on a natural language text description of a user specified business requirement.

FIG. 5 illustrates an exemplary process 500 for identifying the workflow pattern clusters for generating different types of workflows.

FIG. 6 illustrates an exemplary GUI view 600 displayed by the workflow management and automation tool for the user to design a workflow with a business requirement description.

FIG. 7 illustrates an exemplary GUI view 700 displayed by the workflow management and automation tool including an editable version of the workflow template 701.

FIG. 8 is a functional diagram illustrating a programmed computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

The fundamental units of work are tasks, processes, and workflows. A task is the basic building block of all work. Tasks are performed by individuals, but they can vary dramatically in complexity and time required for completion. Tasks may be divided into two types: single step and multi-step. When tasks are grouped together to achieve a desired result or objective, they form a process. For example, when an employee needs help solving an information technology (IT) issue, the employee initiates a process made up of multiple tasks. Processes that become interdependent with other people or processes are called workflows. A workflow comprises the interdependent processes and people required to reach a result that no single participant can achieve alone.

For example, submitting a help-desk request to IT is one element of a larger workflow that ultimately resolves the issue. Processes contained in the IT department are set in motion by requests, leading to prioritization, assignment, and fulfillment. The span of activities from problem to solution, and every person involved, comprises a workflow. The help-desk ticket workflow example may include a number of processes. During the first process, the employee with the broken equipment submits and tracks a help ticket. During the second process, Help Staff prioritizes and investigates the help ticket. During the third process, a technician visits the employee to see the problem in person. A process may include multiple tasks. For example, during the third process, the visit from a technician involves assigning the problem, determining the employee's location, and confirming that it is a good time for a visit, etc.

A cloud-based workflow management and automation tool may be used to allow users to design, build, and manage automated processes and workflows. There are a number of benefits that can be gained by using such a system, including improved efficiency, improved accuracy, better visibility, improved customer service, and the like.

For example, a workflow management and automation tool may provide step-by-step guidance for resolving processes and enable agents to easily manage the lifecycle of cases by guiding them through sequences of tasks. The workflows that are associated with a specific type of case and the activities that need to be completed to resolve cases of this type are detailed in the tool. The tool may also include a graphical user interface (GUI) that helps users to visualize the entire lifecycle of a workflow.

In some existing workflow management and automation tools, a workflow may be automatically generated based on a user's text description. For example, a user provided text description of at least a portion of a desired workflow is received. Context information associated with the desired workflow is determined. Machine learning inputs based at least in part on the text description and the context information are provided to a machine learning model to determine an implementation prediction for the desired workflow. One or more processors are used to automatically implement the implementation prediction as a computerized workflow implementation of at least a portion of the desired workflow. These existing techniques allow users to use free-form natural language to instantiate steps of workflows, which can be displayed as visual steps in the graphical user interface.

However, previously available workflow management and automation tools have different limitations and inefficiencies. Certain tools that convert natural language text to an automation workflow include requesting a user to describe a desired workflow in a step-by-step fashion, which is complicated, tedious. and inefficient.

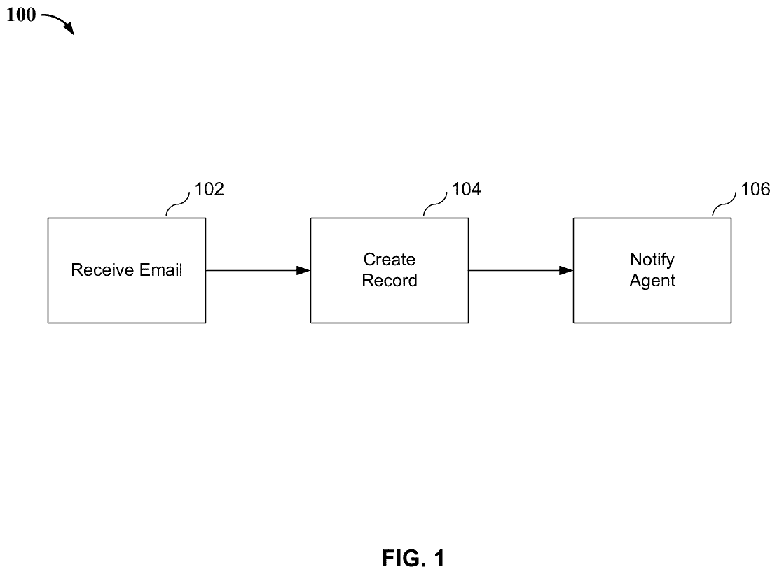

FIG. 1 illustrates an exemplary set of step-by-step descriptions 100 for creating a workflow to handle a received email. At step 102, an email is received. At step 104, a record associated with the email is created. At step 106, a responsible agent is notified. Providing a step-by-step description may be challenging for certain users who are unfamiliar with the capabilities of the workflow management and automation tool.

Requiring the user to describe the desired workflow in a step-by-step fashion is also inefficient. Typically, creating a workflow starts with a business requirement, which is then translated into a technical requirement describing all the actions needed. A business requirement is the business solution for a project, including the customer needs and expectations. A business requirement refers to a specific need or objective that the organization aims to address. Business requirements are typically expressed in non-technical language and are focused on the desired outcomes and functionalities that will support the business processes. For instance, the business requirement of the example above regarding the handling of an email (see FIG. 1) may be “handling and redirecting customer support emails.”

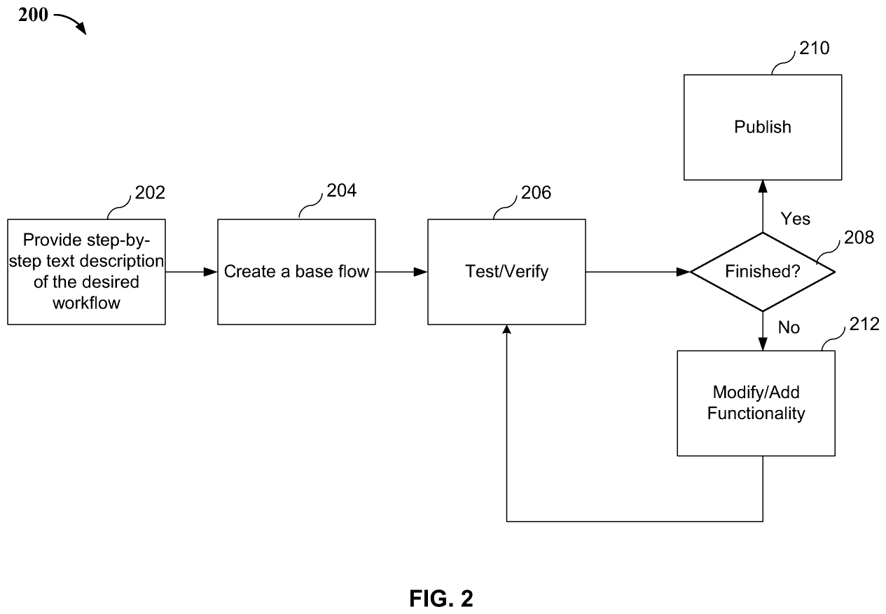

Requiring the user to describe the desired workflow in a step-by-step manner is also not compatible with an iterative and automated workflow creation process. FIG. 2 illustrates an iterative and automated workflow creation process 200 that requires the user to describe the desired workflow in a step-by-step manner. At step 202, a step-by-step text description of the desired workflow is provided by the user. At step 204, a base workflow is created based on the step-by-step text description of the desired workflow. At step 206, the base workflow is tested and verified. At step 208, it is determined whether process 200 is finished based on whether the current workflow is satisfactory. If process 200 is finished, then at step 210, the workflow is published. Otherwise, at step 212, the current workflow is modified or edited, including by adding or modifying the functionality of the workflow. With an iterative creation process, such as process 200 above, the user does not know in advance all the necessary steps that will be included in the final workflow, thereby making a system that requires step-by-step description less compatible and useful.

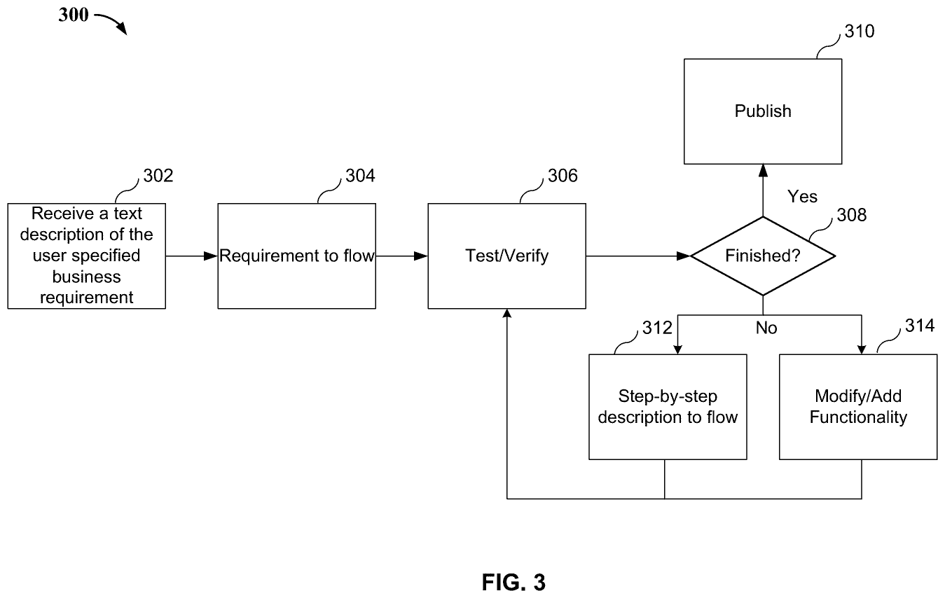

In the present application, a workflow management and automation tool that automatically generates a workflow based on a user specified business requirement is disclosed. FIG. 3 illustrates an exemplary workflow management and automation tool 300 that automatically generates a workflow based on a user specified business requirement provided in a natural language format.

At step 302, a natural language text description of the user specified business requirement for creating a workflow is received from the user. At step 304, a base workflow based on the text description of the user specified business requirement is generated. At step 306, the base workflow is tested and verified. At step 308, it is determined whether process 300 is finished based on whether the current workflow is satisfactory. If process 300 is finished, then at step 310, the workflow is published. Otherwise, at step 312, at least a portion of a step-by-step text description of the desired workflow is provided by the user and a modified workflow is generated based on the at least a portion of the step-by-step text description of the desired workflow. Alternatively, at step 314, the current workflow is modified or edited, including by adding or modifying the functionality of the workflow.

The techniques disclosed herein provide many benefits. For example, in some implementations, a workflow management and automation tool requests a user to provide a general business requirement described in natural language, instead of a step-by-step natural language description of the desired workflow. After the base workflow is generated, it may be refined by a traditional iterative process. Using a graphical user interface can be challenging for inexperienced users, especially since there may be hundreds of available steps. The techniques disclosed herein reduce the user learning curve, promote best practices for novice users, and help experienced users discover new features.

In the present application, improved techniques for a workflow management and automation tool are disclosed. A plurality of workflow patterns is clustered into a plurality of workflow pattern clusters using a clustering machine learning model based at least in part on a plurality of existing workflows and associated business requirement descriptions. A workflow predictive machine learning model is trained using the plurality of workflow pattern clusters. A business requirement description of a desired workflow is received. A version of the business requirement description is provided to the workflow predictive machine learning model. A template for the desired workflow is generated by the workflow predictive machine learning model at least in part by identifying one of the plurality of workflow pattern clusters corresponding to the business requirement description and using a portion of the workflow predictive machine learning model trained using the identified workflow pattern cluster. An editable version of the template for the desired workflow is provided.

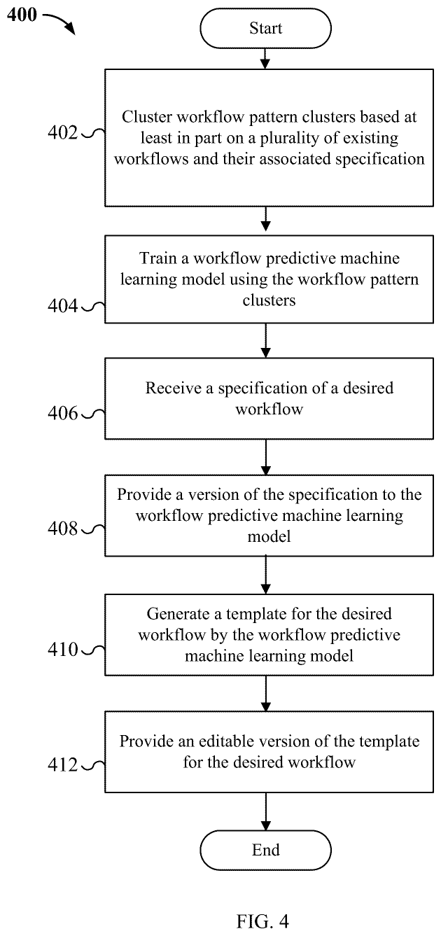

FIG. 4 illustrates an exemplary process 400 for generating a base workflow based on a natural language text description of a user specified business requirement. In some embodiments, process 400 may be performed by step 302 and step 304 of process 300 in FIG. 3.

At step 402, a plurality of workflow patterns is clustered into one or more workflow pattern clusters using a clustering machine learning model based at least in part on a plurality of existing workflows and associated business requirement descriptions.

Cluster analysis or clustering is the grouping of a set of objects in such a way that objects in the same group (called a cluster) are more similar (in some specific sense defined by the analyst) to each other than to those in other groups (clusters). Clustering may also be referred to as unsupervised machine learning. To perform clustering, labels for past known outcomes—a dependent, y, target or label variable—are generally unnecessary. Unsupervised learning is a paradigm in machine learning where, in contrast to supervised learning and semi-supervised learning, algorithms learn patterns exclusively from unlabeled data. The clustering algorithms may be density-based spatial clustering of applications with noise (DBSCAN). However, other clustering algorithms may also be used.

A workflow includes one or more workflow patterns. A workflow may be composed with one or more workflow patterns. In other words, a combination of one or more workflow patterns forms a workflow. A workflow pattern may be any components of a workflow in a certain pattern. For example, a workflow pattern may include any patterns, including a plurality of tasks arranged in a certain sequence, connected via certain branching conditions or a branching structure, triggered by certain triggers, sharing certain similarities or features, receiving certain similar types of inputs, or outputting certain similar types of outputs, and the like. A particular workflow pattern may include a branch decision with three different branches, each being executed depending on a different set of criteria. Another workflow pattern may include a branch decision with two different branches.

A workflow is a particular implementation of a combination of patterns. Therefore, two workflows composed of the same single common pattern are usually not identical to each other. The two workflows may be similar in sharing the same workflow pattern, but each may have different tasks to handle different inputs, generate different outputs, and have different specific contexts, environments, infrastructures, or requirements. But a machine learning model can be used to identify a common workflow pattern that is shared by the two workflows.

For example, one workflow corresponds to a business requirement of handling customers emails and a second workflow corresponds to a business requirement of handling a customer request that is entered via a customer portal. And a clustering machine learning model may identify a workflow pattern cluster/group for handling different types of customer requests. The workflow pattern may include a first task for receiving the customer request via one of the communication methods, such as receiving the customer request via an email, a helpdesk message, a portal entry, a GUI element, and the like. The second task of the workflow pattern may be a task for creating a record associated with the customer request. And the third task of the workflow pattern may be a task for notifying a responsible agent via one of the communication methods, such as notifying the agent via an email, a portal entry, a GUI element, and the like.

In another example, two different workflows (workflow A and workflow B) are each designed for a business requirement of handling a different type of errors when an application programming interface (API) is called. And a clustering machine learning model may identify a workflow pattern cluster for handling errors of API calls. The workflow pattern may include a trigger, an API call, and an error-handling task. Workflow A and workflow B sharing the same workflow pattern may have different triggers, APIs, and error-handling tasks. Triggers determine when a workflow logic executes. One trigger type includes a record trigger, which executes the workflow when a record is created or updated. Another trigger type is a date trigger, which executes the workflow at a specific time or interval. Another trigger type includes an application trigger, which executes the workflow when something happens on an instance, such as receiving an email. Workflow A may have a daily trigger, a Google Translate API, and an error-handling task of logging the error on the screen. Workflow B may have a yearly trigger, an OpenAI API, and the error-handling task of sending an email to the development team about the error.

In order to identify the various workflow pattern clusters that may be used to generate different types of workflows to handle different situations, a set of exemplary workflows and their associated text descriptions of business requirements may be used as the input data for the clustering machine learning model.

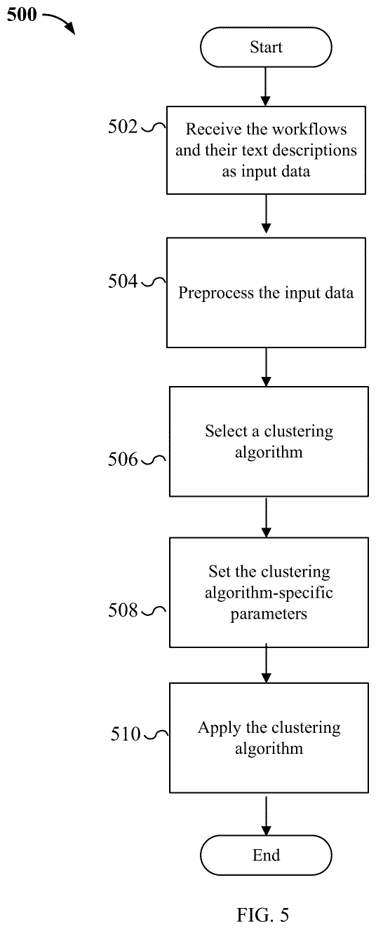

FIG. 5 illustrates an exemplary process 500 for identifying the workflow pattern clusters for generating different types of workflows. In some embodiments, process 500 is performed at step 402 of process 400 in FIG. 4.

At step 502, a set of workflows and their associated text descriptions of business requirements are received as input data. In some embodiments, the set of workflows and their associated business requirement descriptions are workflows that are designed by experienced or professional workflow developers. The advantage of using workflows that are designed by experienced workflow developers is that the workflows are designed based on best practices. However, the set of workflows may also include other previously created workflows, including some that are designed by novices or non-technical users.

At step 504, the input data is preprocessed. For example, any missing values in the set of input data may be handled. The input data may be standardized or normalized.

At step 506, a clustering algorithm is selected. For example, the clustering algorithm may be K-means, Hierarchical Clustering, DBSCAN, and the like.

At step 508, the clustering algorithm-specific parameters are set. For example, the number of clusters may be set for the clustering algorithm.

At step 510, the clustering algorithm is applied. The input data is transformed into embeddings, and data points are assigned to clusters. Embeddings are the representations of values or objects, such as the workflows and the associated text descriptions of their business requirements. Embeddings translate the values or objects into a mathematical form (e.g., vectors or matrices). Embeddings enable machine learning models to find similar objects. Given an object or a value, a machine learning model that uses embeddings could find similar objects or values, and these similar objects or values are grouped into a cluster. The workflow pattern clusters are the clusters identified by the clustering machine learning model.

Referring back to process 400 in FIG. 4, at step 404, a workflow predictive machine learning model is then trained using the plurality of workflow pattern clusters. After the various workflow pattern clusters have been identified at step 402, the workflow pattern clusters are used to train a workflow predictive machine learning model to predict workflows based on business requirements. For each workflow pattern cluster, the predictive machine learning model learns from all the workflows that have the workflow pattern. This enables the predictive machine learning model to detect from a text description of a business requirement a particular workflow pattern, and then predict a corresponding workflow that follows that pattern but is specific to the particular business requirement. Because the business requirement description may not include all the details, the workflow predictive machine learning model may in some cases only be able to generate a base workflow or workflow template that is not complete or exact. For example, the base workflow predicted by the model may only be accurate up to a certain percentage, such as 60%, 70%, or 80%, and may include placeholder tasks or placeholder components (i.e., components of the workflow with certain information or parameters that are left blank or missing). However, such a base workflow provides a very good starting point for the subsequent portion of the iterative and automated workflow creation process (see e.g., steps 306, 308, 310, 312, and 314 of process 300).

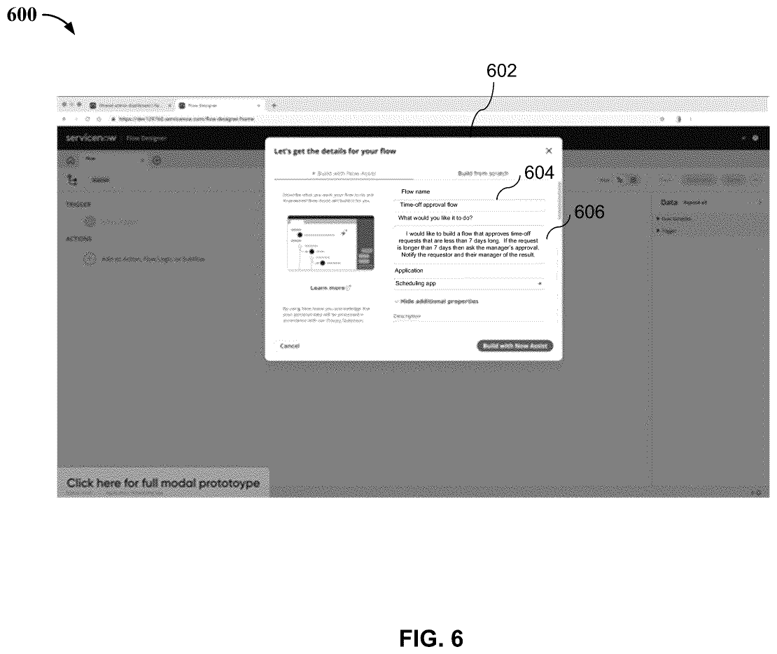

At step 406, specification of a desired workflow is received. For example, the specification is a business requirement description of the desired workflow. FIG. 6 illustrates an exemplary GUI view 600 displayed by the workflow management and automation tool for the user to design a workflow with a business requirement description. View 600 includes a window 602 for the user to enter the details of the desired workflow. For example, window 602 allows the user to enter a name for the desired workflow via a GUI element 604. The name entered is “time off approval flow.” Window 604 additionally prompts the user to provide a business requirement description associated with the desired workflow via a GUI element 606.

At step 408, a version of the specification is provided to the workflow predictive machine learning model. Since the business requirement description is any text that is entered by the user, the description may have errors. Therefore, the business requirement description may be corrected during this step. The version of the business requirement description may be one that has been standardized or normalized. The business requirement description may also be transformed to a format that is compatible as input to the workflow predictive machine learning model. For example, the input string of the business requirement description may be transformed into a corresponding embedding, which is a representation of the business requirement description in a mathematical form (e.g., vectors or matrices).

At step 410, a template for the desired workflow is generated by the workflow predictive machine learning model. One of the plurality of workflow pattern clusters corresponding to the business requirement description is identified. A portion of the workflow predictive model trained using the identified workflow pattern cluster is used to generate the template for the desired workflow. In some embodiments, based on the input business requirement description, at least one of the plurality of workflow pattern clusters is identified as a workflow pattern cluster that corresponds to the business requirement description. For example, suppose that the user enters the business requirement description as “Handling a message received via the customer helpdesk,” and the workflow pattern cluster/group identified may be a workflow pattern cluster for handling different types of customer requests, including a customer request received via an email, a helpdesk message, a portal entry, a GUI element, and the like. In another example, the user is trying to create a workflow for handling time off approval, and the user enters the business requirement description as shown in GUI element 606. The workflow pattern cluster identified may be a workflow pattern cluster for handling different types of approval, including approval for time off, approval for installing a software on an employee laptop, approval for purchasing a piece of equipment, approval for a business trip, and the like. After the workflow pattern cluster is identified, the portion of the workflow predictive machine learning model that was trained using the identified workflow pattern cluster may be used to generate a template for the desired workflow.

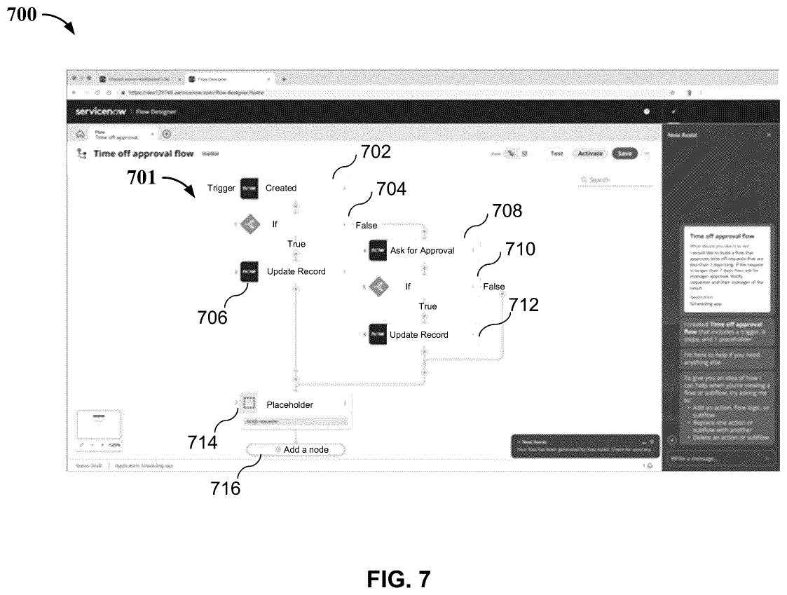

At step 412, an editable version of the template for the desired workflow is provided. FIG. 7 illustrates an exemplary GUI view 700 displayed by the workflow management and automation tool, including an editable version of the workflow template 701. Workflow template 701 begins with a trigger 702, a branch decision 704, task 708 for asking for approval, a second branch decision 710, a task 712 for updating the record, a task 706 for updating the record, a placeholder task 714, and a GUI element 716 for the user to add an additional node or workflow component at the end of the workflow.

Because the provided business requirement text description may not include all the details, the workflow predictive machine learning model is able to generate a base workflow or workflow template that may not be complete or exact. For example, workflow template 701 predicted by the model may only be accurate up to a certain percentage, such as 60%, 70%, or 80%, and may include a placeholder task or placeholder components (i.e., components of the workflow with certain information or parameters that are left blank or missing). However, workflow template 701 provides a very good starting point for the subsequent portion of the iterative and automated workflow creation process (see e.g., steps 306, 308, 310, 312, and 314 of process 300).

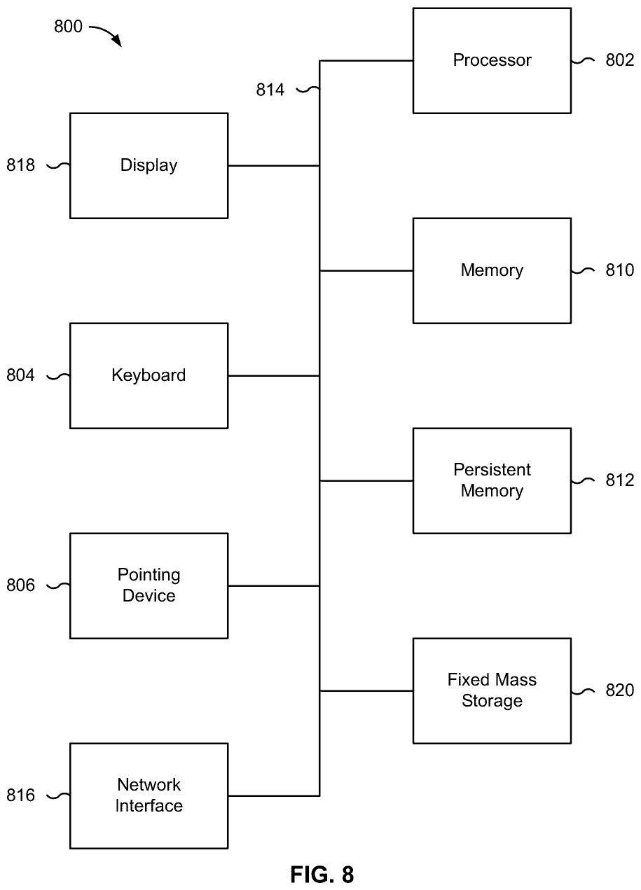

FIG. 8 is a functional diagram illustrating a programmed computer system. In some embodiments, processes 200, 300, 400, and 500 in FIGS. 2-5, respectively, are executed by computer system 800. Computer system 800 is an example of a processor.

In the example shown, computer system 800 includes various subsystems as described below. Computer system 800 includes at least one microprocessor subsystem (also referred to as a processor or a central processing unit (CPU)) 802. Computer system 800 can be physical or virtual (e.g., a virtual machine). For example, processor 802 can be implemented by a single-chip processor or by multiple processors. In some embodiments, processor 802 is a general-purpose digital processor that controls the operation of computer system 800. Using instructions retrieved from memory 810, processor 802 controls the reception and manipulation of input data, and the output and display of data on output devices (e.g., display 818).

Processor 802 is coupled bi-directionally with memory 810, which can include a first primary storage, typically a random-access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also, as is well known in the art, primary storage typically includes basic operating instructions, program code, data, and objects used by the processor 802 to perform its functions (e.g., programmed instructions). For example, memory 810 can include any suitable computer-readable storage media, described below, depending on whether, for example, data access needs to be bi-directional or uni-directional. For example, processor 802 can also directly and very rapidly retrieve and store frequently needed data in a cache memory (not shown).

Persistent memory 812 (e.g., a removable mass storage device) provides additional data storage capacity for computer system 800, and is coupled either bi-directionally (read/write) or uni-directionally (read only) to processor 802. For example, persistent memory 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of fixed mass storage 820 is a hard disk drive. Persistent memory 812 and fixed mass storage 820 generally store additional programming instructions, data, and the like that typically are not in active use by the processor 802. It will be appreciated that the information retained within persistent memory 812 and fixed mass storages 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, pointing device 806 can be a mouse, stylus, track ball, or tablet, and is useful for interacting with a graphical user interface.

Network interface 816 allows processor 802 to be coupled to another computer, computer network, or telecommunications network using a network connection as shown. For example, through network interface 816, processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect computer system 800 to an external network and transfer data according to standard protocols. Processes can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method comprising:
clustering a plurality of workflow patterns into one or more workflow pattern clusters based at least in part on a plurality of existing workflows and associated specifications;
receiving a specification of a desired workflow; and
generating a template for the desired workflow via a workflow predictive model, wherein generating the template includes:
identifying one of the one or more workflow pattern clusters corresponding to the specification of the desired workflow; and
using a portion of the workflow predictive model trained using the identified one workflow pattern cluster to generate the template for the desired workflow.

2. The method of claim 1, further comprising:
training the workflow predictive model using the one or more workflow pattern clusters.

3. The method of claim 1, wherein the desired workflow comprises one or more workflow patterns.

4. The method of claim 1, wherein one of the plurality of workflow patterns comprises one or more of the following: a plurality of tasks arranged in a sequence, a plurality of tasks connected via a branch decision, or a plurality of tasks triggered by a particular trigger.

5. The method of claim 1, wherein the plurality of existing workflows comprises workflows that are designed by a plurality of human workflow developers.

6. The method of claim 1, further comprising:
transforming the plurality of existing workflows into corresponding workflow embeddings; and
transforming the associated specifications into corresponding description embeddings.

7. The method of claim 1, wherein the associated specifications comprise text descriptions in a natural language format, and wherein the specification of the desired workflow comprises a text description in a natural language format.

8. The method of claim 1, further comprising:
transforming the specification of the desired workflow into a version of the specification provided to the workflow predictive model, comprising by:
correcting one or more errors in the specification of the desired workflow;
standardizing or normalizing the specification of the desired workflow; and
transforming the specification of the desired workflow into a corresponding description embedding.

9. The method of claim 1, further comprising:
providing an editable version of the template for the desired workflow.

10. The method of claim 9, wherein the editable version of the template for the desired workflow comprises one or more placeholder editable tasks.

11. The method of claim 9, wherein the editable version of the template for the desired workflow comprises one or more graphical user interface (GUI) elements for adding additional workflow components.

12. A system, comprising:
a processor configured to:
cluster a plurality of workflow patterns into one or more workflow pattern clusters based at least in part on a plurality of existing workflows and associated specifications;
receive a specification of a desired workflow; and
generate a template for the desired workflow via a workflow predictive model, wherein generating the template includes:
identifying one of the one or more workflow pattern clusters corresponding to the specification of the desired workflow; and
using a portion of the workflow predictive model trained using the identified one workflow pattern cluster to generate the template for the desired workflow; and
a memory coupled to the processor and configured to provide the processor with instructions.

13. The system of claim 12, wherein the processor is further configured to:
train the workflow predictive model using the one or more workflow pattern clusters.

14. The system of claim 12, wherein one of the plurality of workflow patterns comprises one or more of the following: a plurality of tasks arranged in a sequence, a plurality of tasks connected via a branch decision, or a plurality of tasks triggered by a particular trigger.

15. The system of claim 12, wherein the plurality of existing workflows comprises workflows that are designed by a plurality of human workflow developers.

16. The system of claim 12, wherein the processor is configured to:
transform the plurality of existing workflows into corresponding workflow embeddings; and
transform the associated specifications into corresponding description embeddings.

17. The system of claim 12, wherein the associated specifications comprise text descriptions in a natural language format, and wherein the specification of the desired workflow comprises a text description in a natural language format.

18. The system of claim 12, wherein the processor is configured to:
provide an editable version of the template for the desired workflow.

19. The system of claim 18, wherein the editable version of the template for the desired workflow comprises one or more placeholder editable tasks.

20. A computer program product embodied in a non-transitory computer readable medium and comprising computer instructions for:
clustering a plurality of workflow patterns into one or more workflow pattern clusters based at least in part on a plurality of existing workflows and associated specifications;
receiving a specification of a desired workflow; and
generating a template for the desired workflow via a workflow predictive model, wherein generating the template includes:
identifying one of the one or more workflow pattern clusters corresponding to the specification of the desired workflow; and
using a portion of the workflow predictive model trained using the identified one workflow pattern cluster to generate the template for the desired workflow.
